(19) United States
(12) Patent Application Publication
(10) Pub. No.: US 2025/0055133 A1
(43) Pub. Date: Feb. 13, 2025

(54) ALL-SOLID-STATE BATTERY AND MANUFACTURING METHOD OF ALL-SOLID-STATE BATTERY

(71) Applicants: TOYOTA JIDOSHA KABUSHIKI KAISHA, Toyota-shi (JP); HONDA MOTOR CO., LTD., Toyo (JP)

(72) Inventors: Takumi TANAKA, Takarazuka-shi (JP); Kazuma Oue, Wako-shi (JP)

(73) Assignees: TOYOTA JIDOSHA KABUSHIKI KAISHA, Toyota-shi (JP); HONDA MOTOR CO., LTD., Tokyo (JP)

(21) Appl. No.: 18/782,329

(22) Filed: Jul. 24, 2024

(30) Foreign Application Priority Data
Aug. 10, 2023 (JP) 2023-131538

(51) Int. Cl. H01M 50/449; H01M 4/36; H01M 10/0562

(52) U.S. Cl. CPC H01M 50/449; H01M 4/366; H01M 10/0562

(57) ABSTRACT

This disclosure provides an all-solid-state battery having a first current collector, a first electrode layer, a solid electrolyte layer, a second electrode layer, and a second current collector in this order. The first electrode layer includes a first active material. The second electrode layer includes a second active material. When the all-solid-state battery is seen in a plan view from a thickness direction, the area of the second electrode layer is larger than the area of the first electrode layer. A first surface of the first electrode layer on the side of the solid electrolyte layer has an inner region and an outer region. The all-solid-state battery has, between the outer region and the second electrode layer in the thickness direction, the solid electrolyte layer and either (i) a space or (ii) a low-elastic-modulus member having a lower elastic modulus than the second electrode layer and the solid electrolyte layer.

### CROSS-REFERENCE TO RELATED APPLICATION

This application claims priority to Japanese Patent Application No. 2023-131538 filed on Aug. 10, 2023 incorporated herein by reference in its entirety.

### BACKGROUND

### 1. Technical Field

This disclosure relates to an all-solid-state battery and a manufacturing method of an all-solid-state battery.

### 2. Description of Related Art

An all-solid-state battery is a battery having a solid electrolyte layer between a positive electrode layer and a negative electrode layer, and, compared with a liquid-based battery that has an electrolytic solution including a combustible organic solvent, has an advantage in that it is easy to simplify a safety device.

An all-solid-state battery is manufactured by sandwiching a solid electrolyte layer between a positive electrode and a negative electrode and pressure-bonding them in a thickness direction. Japanese Unexamined Patent Application Publication No. 2022-062579 (JP 2022-062579 A) discloses an all-solid-state battery including a solid electrolyte layer, one electrode and the other electrode that sandwich the solid electrolyte layer, and a first current collector that, together with the solid electrolyte layer, sandwiches the one electrode. An end portion of the one electrode is inclined toward the first current collector, and, as seen in a plan view, a marginal edge of an end portion of the other electrode on the side of the solid electrolyte layer is disposed between a marginal edge of the end portion of the one electrode on the side of the solid electrolyte layer and a marginal edge of the end portion of the one electrode on the side of the first current collector. In JP 2022-062579 A, as the one electrode is inclined toward the first current collector, even when the all-solid-state battery is pressed from the side of the first current collector, a pressure is not directly applied and thus stress concentration in the solid electrolyte layer during pressure-bonding is reduced.

### SUMMARY

In electrode layers of all-solid-state batteries, an active material that changes in volume during charge and discharge is sometimes used. The inventors of the present application found, as a new challenge, that when expansion of an active material included in one electrode layer occurred during charge and discharge, an area near a perimeter of the opposite other electrode layer might become damaged due to stress concentrating therein.

This disclosure has been made in view of the above-described problem, and a main object thereof is to provide an all-solid-state battery in which damage to an area near a perimeter of an electrode layer resulting from charge and discharge is less likely to occur.

[1]

An all-solid-state battery including a first current collector, a first electrode layer, a solid electrolyte layer, a second electrode layer, and a second current collector in this order, wherein:
the first electrode layer includes a first active material;
the second electrode layer includes a second active material that changes in volume during charge and discharge;
when the all-solid-state battery is seen in a plan view from a thickness direction, the area of the second electrode layer is larger than the area of the first electrode layer;
a first surface of the first electrode layer on the side of the solid electrolyte layer has an inner region and an outer region that is disposed on the outer side of the inner region and includes an end portion; and
the all-solid-state battery has, between the outer region and the second electrode layer in the thickness direction, the solid electrolyte layer and either (i) a space or (ii) a low-elastic-modulus member having a lower elastic modulus than the second electrode layer and the solid electrolyte layer.

[2]

The all-solid-state battery according to [1], wherein the thickness of the first electrode layer decreases from a border between the inner region and the outer region toward the end portion.

[3]

The all-solid-state battery according to [1] or [2], wherein the space is disposed between the outer region and the solid electrolyte layer in the thickness direction.

[4]

The all-solid-state battery according to [1] or [2], wherein the low-elastic-modulus member is disposed between the outer region and the solid electrolyte layer in the thickness direction.

[5]

The all-solid-state battery according to [1] or [2], wherein:
the solid electrolyte layer is disposed so as to cover the inner region and the outer region; and
the space is disposed between the solid electrolyte layer covering the outer region and the second electrode layer in the thickness direction.

[6]

The all-solid-state battery according to [1] or [2], wherein:
the solid electrolyte layer is disposed so as to cover the inner region and the outer region; and
the low-elastic-modulus member is disposed between the solid electrolyte layer covering the outer region and the second electrode layer in the thickness direction.

[7]

The all-solid-state battery according to [1] or [2], wherein:
the solid electrolyte layer has a first solid electrolyte layer and a second solid electrolyte layer from the side of the first electrode layer;
the first solid electrolyte layer is disposed so as to cover the inner region and the outer region;
the second solid electrolyte layer is disposed in contact with the second electrode layer; and
the space is disposed between the first solid electrolyte layer covering the outer region and the second solid electrolyte layer in the thickness direction.

[8]

The all-solid-state battery according to [1] or [2], wherein:
the solid electrolyte layer has a first solid electrolyte layer and a second solid electrolyte layer from the side of the first electrode layer;
the first solid electrolyte layer is disposed so as to cover the inner region and the outer region;
the second solid electrolyte layer is disposed in contact with the second electrode layer; and
the low-elastic-modulus member is disposed between the first solid electrolyte layer covering the outer region and the second solid electrolyte layer in the thickness direction.

[9]

The all-solid-state battery according to any one of [1] to [8], wherein the second electrode layer is a negative electrode active material layer and includes an alloy-based active material as the second active material.

[10]

A manufacturing method of the all-solid-state battery according to any one of [1] to [9], including:
a first stack preparation step of preparing a first stack having the first current collector and the first electrode layer;
a second stack preparation step of preparing a second stack having the second current collector and the second electrode layer;
a first stack pressure-molding step of performing pressure-molding on the first stack; and
a stacking step of, after the first stack pressure-molding step, stacking the first stack and the second stack through the solid electrolyte layer, wherein
in the first stack pressure-molding step, isostatic pressing is performed to decrease the thickness of the first electrode layer from a border between the inner region and the outer region toward the end portion.

[11]

The manufacturing method of the all-solid-state battery according to [10], wherein the isostatic pressing is performed without a support plate being disposed on a surface of the first stack on the side of the first electrode layer.

This disclosure has the advantage of being able to provide an all-solid-state battery in which damage to an area near a perimeter of an electrode layer resulting from charge and discharge is less likely to occur.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic sectional view showing one example (first embodiment) of an all-solid-state battery in this disclosure;

FIG. 1B is a schematic sectional view showing one example (first embodiment) of the all-solid-state battery in this disclosure;

FIG. 2A is a schematic sectional view showing another example (second embodiment) of the all-solid-state battery in this disclosure;

FIG. 2B is a schematic sectional view showing another example (second embodiment) of the all-solid-state battery in this disclosure;

FIG. 3A is a schematic sectional view showing yet another example (third embodiment) of the all-solid-state battery in this disclosure;

FIG. 3B is a schematic sectional view showing yet another example (third embodiment) of the all-solid-state battery in this disclosure;

FIG. 4 is a schematic sectional view showing still another example (stacked battery) of the all-solid-state battery in this disclosure;

FIG. 5A is a schematic sectional view showing one example of a manufacturing method of the all-solid-state battery of the first embodiment in this disclosure;

FIG. 5B is a schematic sectional view showing one example of the manufacturing method of the all-solid-state battery of the first embodiment in this disclosure;

FIG. 5C is a schematic sectional view showing one example of the manufacturing method of the all-solid-state battery of the first embodiment in this disclosure;

FIG. 5D is a schematic sectional view showing one example of the manufacturing method of the all-solid-state battery of the first embodiment in this disclosure;

FIG. 6A is a schematic sectional view showing one example of a manufacturing method of the all-solid-state battery of the second embodiment in this disclosure;

FIG. 6B is a schematic sectional view showing one example of the manufacturing method of the all-solid-state battery of the second embodiment in this disclosure;

FIG. 6C is a schematic sectional view showing one example of the manufacturing method of the all-solid-state battery of the second embodiment in this disclosure;

FIG. 6D is a schematic sectional view showing one example of the manufacturing method of the all-solid-state battery of the second embodiment in this disclosure;

FIG. 7A is a schematic sectional view showing one example of a manufacturing method of the all-solid-state battery of the third embodiment in this disclosure;

FIG. 7B is a schematic sectional view showing one example of the manufacturing method of the all-solid-state battery of the third embodiment in this disclosure;

FIG. 7C is a schematic sectional view showing one example of the manufacturing method of the all-solid-state battery of the third embodiment in this disclosure;

FIG. 7D is a schematic sectional view showing one example of the manufacturing method of the all-solid-state battery of the third embodiment in this disclosure;

FIG. 8A is a schematic sectional view showing one example of a manufacturing method of the all-solid-state battery (stacked battery) in this disclosure;

FIG. 8B is a schematic sectional view showing one example of the manufacturing method of the all-solid-state battery (stacked battery) in this disclosure;

FIG. 8C is a schematic sectional view showing one example of the manufacturing method of the all-solid-state battery (stacked battery) in this disclosure;

FIG. 9 is a schematic sectional view showing one example of the manufacturing method of the all-solid-state battery (stacked battery) in this disclosure;

FIG. 10A is a schematic sectional view showing one example of conventional all-solid-state batteries;

FIG. 10B is a schematic sectional view showing one example of conventional all-solid-state batteries;

FIG. 11A is a schematic sectional view of a battery after a charge-discharge test in Example;

FIG. 11B is a schematic sectional view of a battery after the charge-discharge test in Comparative Example; and

FIG. 12 is a result of comparing coulombic efficiencies at each charge rate in Example and Comparative Example.

### DETAILED DESCRIPTION OF EMBODIMENTS

This disclosure will be described in detail below using the drawings. The drawings shown in the following are shown as examples, and the sizes of parts and the shapes of parts may be exaggerated to facilitate understanding.

### A. All-Solid-State Battery

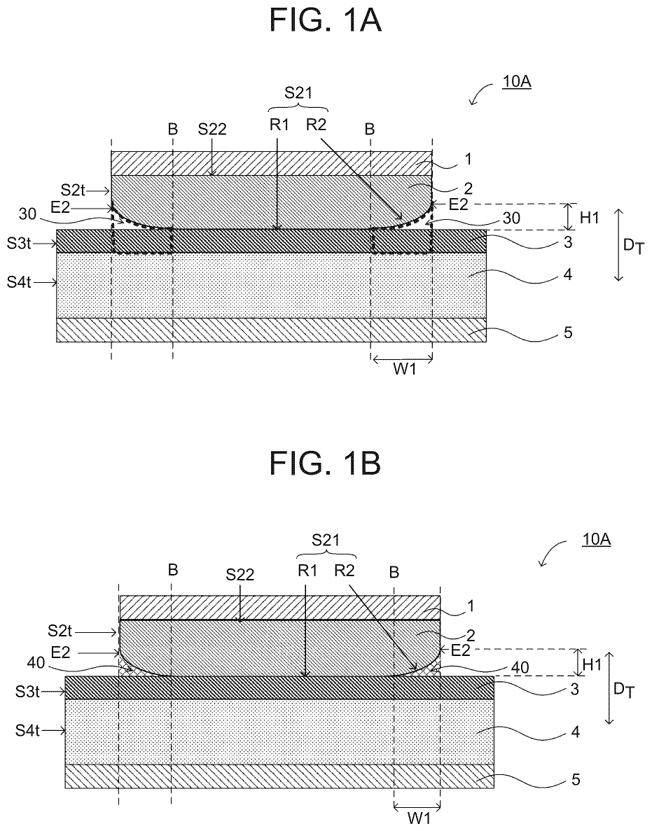

FIG. 1A and FIG. 1B are schematic sectional views showing one example of an all-solid-state battery of this disclosure. As shown in FIG. 1A and FIG. 1B, an all-solid-state battery 10A has a first current collector 1, a first electrode layer 2, a solid electrolyte layer 3, a second electrode layer 4, and a second current collector 5 in this order in a thickness direction D_{T}. While this is not particularly shown in the drawings, the all-solid-state battery 10A may include an outer casing and restraining members to be described later.

In this disclosure, the first electrode layer 2 includes a first active material, and the second electrode layer 4 includes a second active material that changes in volume during charge and discharge. As shown in FIG. 1A and FIG. 1B, when the all-solid-state battery 10A is seen in a plan view from the thickness direction D_{T}, the area of the second electrode layer 4 is larger than the area of the first electrode layer 2. In this disclosure, the all-solid-state battery 10A is characterized in that a first surface S21 of the first electrode layer 2 on the side of the solid electrolyte layer 3 has an inner region R1 and an outer region R2 that is disposed on an outer side of the inner region R1 and includes an end portion E2, and in that the all-solid-state battery 10A has, between the outer region R2 of the first surface S21 and the second electrode layer 4 in the thickness direction D_{T} (inside the dotted boxes), the solid electrolyte layer 3 and either (i) a space 30 or (ii) a low-elastic-modulus member 40 having a lower elastic modulus than the second electrode layer and the solid electrolyte layer.

In the all-solid-state battery 10A shown in FIG. 1A and FIG. 1B, the thickness of the first electrode layer 2 decreases from a border B between the inner region R1 and the outer region R2 toward the end portion E2. As shown in FIG. 1A, the space 30 may be present between the outer region R2 in the first surface S21 of the first electrode layer 2 and the solid electrolyte layer 3 in the thickness direction D_{T}. On the other hand, as shown in FIG. 1B, the low-elastic-modulus member 40 may be disposed between the outer region R2 in the first surface S21 of the first electrode layer 2 and the solid electrolyte layer 3.

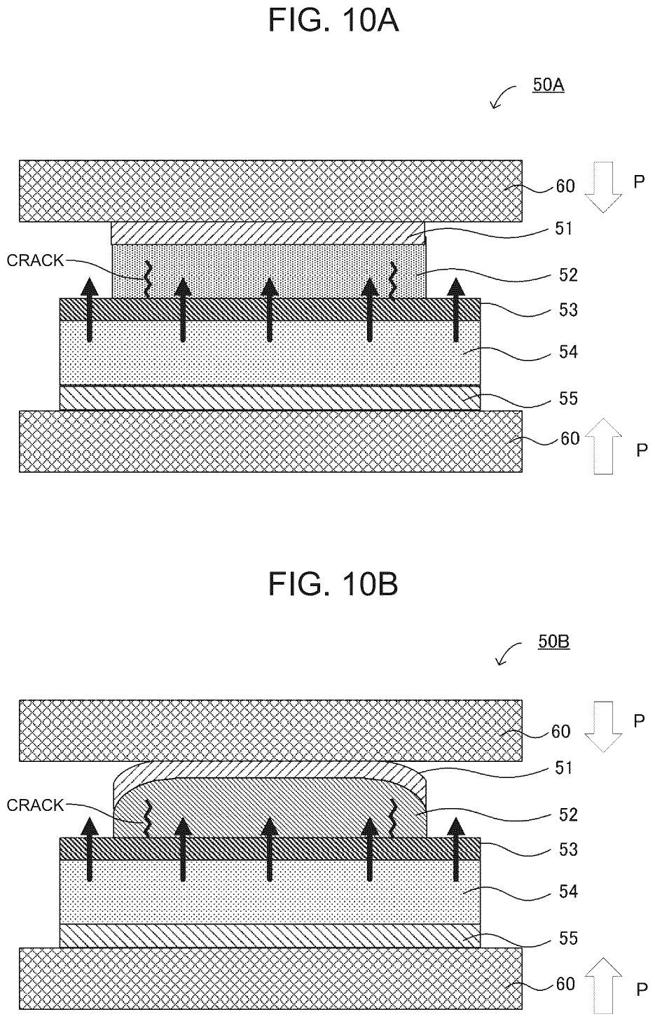

FIG. 10A is a schematic sectional view showing one example of conventional all-solid-state batteries. As in a conventional all-solid-state battery 50A shown in FIG. 10A, it has been hitherto believed important to ensure good contact among a first electrode layer 52, a solid electrolyte layer 53, and a second electrode layer 54 up to an end portion of each layer in order to produce high battery performance. However, if the second electrode layer 54 includes an active material that changes in volume during charge and discharge, when the second electrode layer 54 expands during charge and discharge (the arrows in FIG. 10A and FIG. 10B) in a state where a restraining pressure P is applied to an all-solid-state battery 50 by restraining members 60 in the thickness direction, stress concentrates in an area near a perimeter of the first electrode layer 52, which may result in damage to the area near the perimeter of the first electrode layer 52.

FIG. 10B is a schematic sectional view showing another example of conventional all-solid-state batteries. Depending on the manufacturing method of the conventional all-solid-state battery, as in an all-solid-state battery 50B shown in FIG. 10B, an end portion of the first electrode layer 52 may sag toward the solid electrolyte layer 53. In such an all-solid-state battery 50B, when the second electrode layer 54 expands during charge and discharge, stress concentrates in the area near the perimeter of the first electrode layer 52 and, moreover, bending stress occurs in the area near the perimeter of the first electrode layer 52, so that the area near the perimeter of the first electrode layer 52 is more likely to become damaged. In FIG. 10A and FIG. 10B, reference sign 51 denotes a first current collector and reference sign 55 denotes a second current collector.

JP 2022-062579 A described above aims to reduce stress concentration in the solid electrolyte layer during pressure-bonding, while it makes no mention of the problem that expansion of one electrode during charge and discharge leads to damage to the area near the perimeter of the other electrode layer.

By contrast, as shown in FIG. 1A and FIG. 1B, the all-solid-state battery in this disclosure has the space 30 or the low-elastic-modulus member 40 in addition to the solid electrolyte layer 3 between the outer region R2 of the first electrode layer 2 and the second electrode layer 4. Thus, even when the second electrode layer 4 expands in a state where a restraining pressure is applied in the thickness direction D_{T}, excessive stress concentration in an area near a perimeter of the first electrode layer 2 (a portion of the first electrode layer located at a position overlapping the outer region in the thickness direction and in a nearby area) is less likely to occur, and therefore damage to the area near the perimeter of the first electrode layer 2 is less likely to occur. As a result, interruption of an ion conduction path and an electron conduction path in the area near the perimeter of the first electrode layer 2 can be prevented to avoid a decrease in capacity.

### 1. Structure of All-Solid-State Battery

The all-solid-state battery in this disclosure has a first current collector, a first electrode layer, a solid electrolyte layer, a second electrode layer, and a second current collector.

As shown in FIG. 1A and FIG. 1B, when the all-solid-state battery in this disclosure is seen in a plan view from the thickness direction D_{T}, the area of the second electrode layer 4 is larger than the area of the first electrode layer 2. In other words, an end surface S2t of the first electrode layer 2 is located inward of an end surface S4t of the second electrode layer 4. A ratio (A4/A2) of the area (A4) of the second electrode layer 4 to the area (A2) of the first electrode layer 2 is, for example, higher than 1.0, and may be 1.1 or higher or may be 1.2 or higher. On the other hand, this ratio (A4/A2) is, for example, 1.5 or lower, and may be 1.4 or lower or may be 1.3 or lower. When the area of the second electrode layer 4 is thus larger than the area of the first electrode layer 2, stress is likely to concentrate in the area near the perimeter of the first electrode layer due to expansion of the second electrode layer. On the other hand, in this disclosure, since the all-solid-state battery has the solid electrolyte layer and the space or the low-elastic-modulus member between the outer region of the first electrode layer and the second electrode layer in the thickness direction, excessive stress concentration in the area near the perimeter of the first electrode layer 2 is less likely to occur, and therefore damage to the area near the perimeter of the electrode layer due to charge and discharge is less likely to occur. When the second electrode layer is a negative electrode active material layer, having the aforementioned ratio (A4/A2) can, for example, reduce the likelihood of precipitation of lithium at an end portion of the second electrode layer, which in turn can reduce the likelihood of short circuit.

In the all-solid-state battery in this disclosure, the first surface S21 of the first electrode layer 2 on the side of the solid electrolyte layer 3 has the inner region R1 and the outer region R2 that is disposed on the outer side of the inner region R1 and includes the end portion E2. The all-solid-state battery in this disclosure has, for example, a second surface S22 that is a surface of the first electrode layer 2 on the side of the first current collector 1. The all-solid-state battery may further have the end surface S2t that couples the first surface S21 and the second surface S22 together. In this case, the end portion E2 of the first surface S21 is an edge at which the end surface S2t and the first surface S21 intersect each other.

The all-solid-state battery in this disclosure may have a solid electrolyte layer and a space between the outer region of the first electrode layer and the second electrode layer in the thickness direction. On the other hand, the all-solid-state battery may have a solid electrolyte layer and a low-elastic-modulus member between the outer region of the first electrode layer and the second electrode layer. When the low-elastic-modulus member is disposed, stress concentration in the area near the perimeter of the first electrode layer due to expansion and contraction of the second electrode layer can be prevented, and as excessive deformation is less likely to occur, vibration etc. is absorbed and damage due to impact from an outside can be prevented. The elastic modulus of the low-elastic-modulus member should be at least lower than the elastic modulus of the second electrode layer and the elastic modulus of the solid electrolyte layer, and is preferably lower than that of each layer of the first electrode layer, the solid electrolyte layer, and the second electrode layer.

The low-elastic-modulus member may be any member that has a lower elastic modulus than the second electrode layer and the solid electrolyte layer, and examples include rubber (elastomer), urethane, resin sponge, and resin materials such as plastic.

In this disclosure, as shown in FIG. 1A and FIG. 1B, it is preferable that the thickness of the first electrode layer 2 decrease from the border B between the inner region R1 and the outer region R2 toward the end portion E2. In other words, it is preferable that the outer region R2 of the first surface S21 of the first electrode layer 2 have an inclined surface that is inclined toward the first current collector 1. Thus, concentration of stress in the area near the perimeter of the first electrode layer 2 is even less likely to occur. It is preferable that the outer region R2 of the first surface of the first electrode layer 2 be an inclined surface having a curvature. On the other hand, the outer region R2 is not limited to an inclined surface having a curvature, and may be an inclined surface with one angle or may be an inclined surface with a plurality of angles.

In this disclosure, it is preferable that the density of a portion of the first electrode layer that is located at a position overlapping the outer region in the thickness direction be higher than the density of a portion of the first electrode layer that is located at a position overlapping the inner region in the thickness direction. Such a difference in density is produced by, for example, performing isostatic pressing to be described later. When the density of the portion of the first electrode layer located at the position overlapping the outer region in the thickness direction is high, resistance to impact improves.

As shown in FIG. 1A and FIG. 1B, it is preferable that an entire surface of the second surface S22 be flat. When the entire surface of the second surface S22 is flat, no gap forms between the first electrode layer 2 and a restraining plate in the thickness direction, so that bending stress on the area near the perimeter of the first electrode layer 2 due to expansion of the second electrode layer 4 is less likely to occur, and thus damage to the first electrode layer 2 is even less likely to occur.

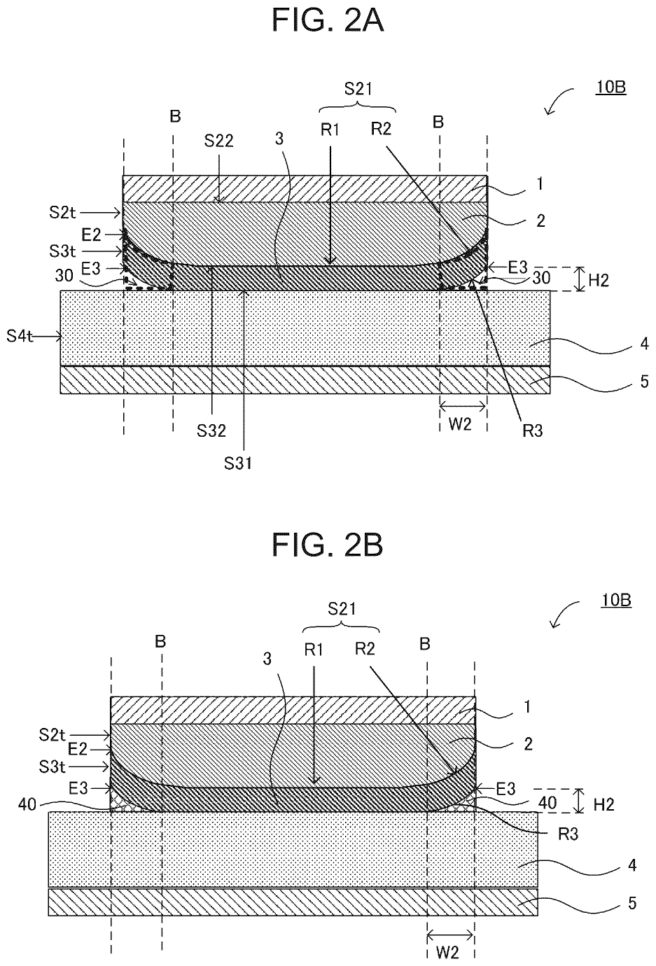

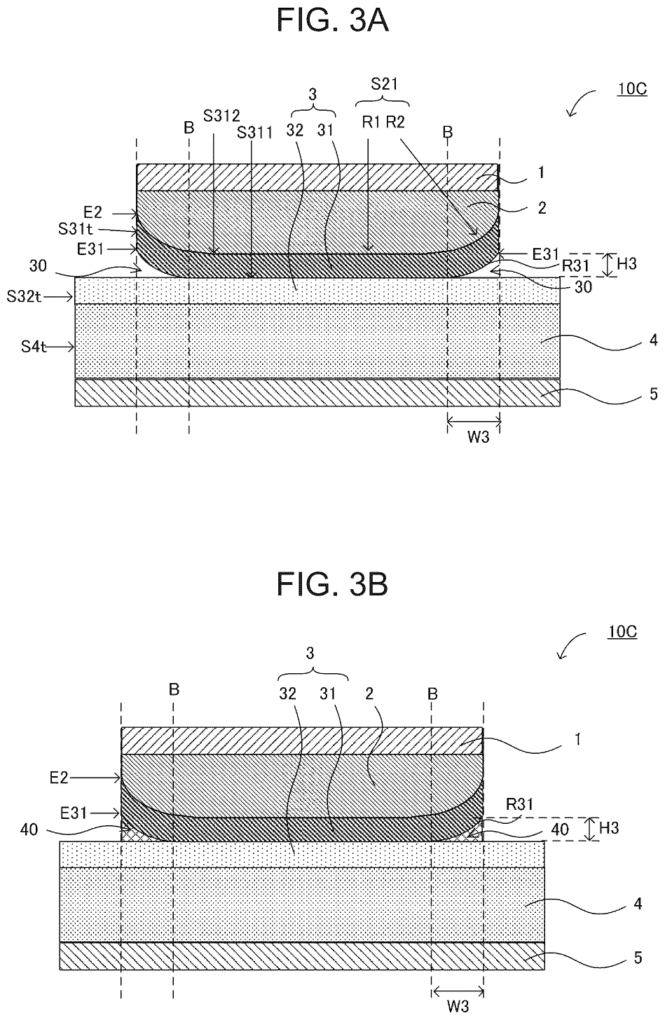

As the all-solid-state battery in this disclosure, a first embodiment illustrated in FIG. 1A and FIG. 1B, a second embodiment illustrated in FIG. 2A and FIG. 2B, and a third embodiment illustrated in FIG. 3A and FIG. 3B can be presented depending on the position of the space or the low-elastic-modulus member.

### (1) First Embodiment

As shown in FIG. 1A and FIG. 1B, in the all-solid-state battery 10A in the first embodiment, the thickness of the first electrode layer 2 decreases from the border B between the inner region R1 and the outer region R2 toward the end portion E2. In the all-solid-state battery 10A shown in FIG. 1A, the space 30 is present between the outer region R2 and the solid electrolyte layer 3 in the thickness direction D_{T}. On the other hand, in the all-solid-state battery 10A shown in FIG. 1B, the low-elastic-modulus member 40 is disposed between the outer region R2 and the solid electrolyte layer 3.

Since the all-solid-state battery in this embodiment has the space or the low-elastic-modulus member, even when the second electrode layer 4 expands in the state where a restraining pressure is applied in the thickness direction, a pressure acting on the area near the perimeter of the first electrode layer as a result of a change in volume of the second active material can be reduced, so that excessive stress concentration in the area near the perimeter of the first electrode layer 2 is less likely to occur. Therefore, damage to the area near the perimeter of the first electrode layer is less likely to occur. In this embodiment, as shown in FIG. 1A and FIG. 1B, the outer region R2 and the solid electrolyte layer 3 are normally disposed apart from each other.

In this embodiment, as seen in a sectional view in the thickness direction, a ratio (H1/W1) of the distance (H1 in FIG. 1A and FIG. 1B) between the end portion E2 and the solid electrolyte layer 3 to the width (W1 in FIG. 1A and FIG. 1B) of the outer region R2 is, for example, 1/50 or higher, and may be 1/10 or higher. On the other hand, this ratio (H1/W1) is, for example, 1 or lower, and may be ⅕ or lower. Specifically, H1 is, for example, 40 μm or larger and 100 μm or smaller, and W1 is, for example, 400 μm or larger and 500 μm or smaller. In the case where the thickness of the first electrode layer 2 is decreased from the border between the inner region and the outer region toward the end portion by isostatic pressing as will be described later, the ratio (H1/W1) is influenced by a ratio between the width and the thickness of the first electrode layer.

In this embodiment, it is preferable that, as seen in a plan view of the all-solid-state battery, the area of the solid electrolyte layer 3 be equal to that of the second electrode layer 4 or larger than that of the second electrode layer 4. That is, it is preferable that an end surface S3t of the solid electrolyte layer 3 be located at the same position as the end surface S4t of the second electrode layer 4 or outward of the end surface S4t. This is because precipitation of Li at the end portion of the second electrode layer is less likely to occur when an entire surface of the second electrode layer is in contact with the solid electrolyte layer 3.

### (2) Second Embodiment

FIG. 2A and FIG. 2B are schematic sectional views showing another example of the all-solid-state battery of this disclosure. In an all-solid-state battery 10B shown in FIG. 2A and FIG. 2B, the thickness of the first electrode layer 2 decreases from the border B between the inner region R1 and the outer region R2 toward the end portion E2. The solid electrolyte layer 3 is disposed so as to cover the inner region R1 and the outer region R2 in the first surface S21 of the first electrode layer 2. Thus, the solid electrolyte layer 3 is disposed so as to conform to the first electrode layer 2. In the all-solid-state battery 10B shown in FIG. 2A, a space is present between the solid electrolyte layer 3 covering the outer region R2 and the second electrode layer 4 in the thickness direction D_{T}. On the other hand, in the all-solid-state battery 10B shown in FIG. 2B, the low-elastic-modulus member 40 is disposed between the solid electrolyte layer 3 covering the outer region R2 and the second electrode layer 4.

Since the all-solid-state battery 10B in this embodiment has the space 30 or the low-elastic-modulus member 40, excessive stress concentration in the area near the perimeter of the first electrode layer 2 is less likely to occur for the reason described above. Thus, cracking of the first electrode layer is less likely to occur. Moreover, in this embodiment, cracking in an area near a perimeter of the solid electrolyte layer is also less likely to occur. Thus, internal short circuit is less likely to occur.

In this embodiment, it is preferable that a surface (outer region R3), on the side of the second electrode layer, of the solid electrolyte layer 3 covering the outer region R2 be an inclined surface having a curvature. On the other hand, this surface is not limited to an inclined surface having a curvature, and may be an inclined surface with one angle or may be an inclined surface with a plurality of angles. Thus, concentration of stress in the area near the perimeter of the solid electrolyte layer and in the area near the perimeter of the first electrode layer is even less likely to occur. It is preferable that the outer region R3 of the solid electrolyte layer 3 be an inclined surface having a curvature. On the other hand, this surface is not limited to an inclined surface having a curvature, and may be an inclined surface with one angle or may be an inclined surface with a plurality of angles. In this embodiment, the outer region R3 is normally disposed apart from the second electrode layer 4.

In this embodiment, the solid electrolyte layer 3 has, for example, a first surface S31 and a second surface S32 that face each other, and the end surface S3t that couples the first surface S31 and the second surface S32 together. The first surface S31 is a surface of the solid electrolyte layer 3 on the side of the second electrode layer 4, and the second surface S32 is a surface of the solid electrolyte layer 3 on the side of the first electrode layer 2. In this embodiment, the first surface S31 of the solid electrolyte layer 3 includes the outer region R3 including an end portion E3.

In this embodiment, as seen in a sectional view in the thickness direction, a ratio (H2/W2) of the distance (H2 in FIG. 2A and FIG. 2B) between the end portion E3 and the second electrode layer 4 to the width (W2 in FIG. 2A and FIG. 2B) of the outer region R3 of the solid electrolyte layer 3 is, for example, 1/50 or higher, and may be 1/10 or higher. On the other hand, this ratio (H2/W2) is, for example, 1 or lower, and may be ⅕ or lower. Specifically, H2 is, for example, 40 μm or larger and 100 μm or smaller, and W2 is, for example, 400 μm or larger and 500 μm or smaller.

### (3) Third Embodiment

FIG. 3A and FIG. 3B are schematic sectional views showing yet another example of the all-solid-state battery of this disclosure. In an all-solid-state battery 10C shown in FIG. 3A and FIG. 3B, the thickness of the first electrode layer 2 decreases from the border B between the inner region R1 and the outer region R2 toward the end portion E2. The solid electrolyte layer 3 has the first solid electrolyte layer 31 and the second solid electrolyte layer 32 from the side of the first electrode layer 2, and the first solid electrolyte layer 31 is disposed so as to cover the inner region R1 and the outer region R2 in the first surface S21 of the first electrode layer 2. Thus, the first solid electrolyte layer 31 is disposed so as to conform to the first electrode layer 2. On the other hand, the second solid electrolyte layer 32 is disposed in contact with the second electrode layer 4. In the all-solid-state battery 10C shown in FIG. 3A, a space is present between the first solid electrolyte layer 31 covering the outer region R2 and the second solid electrolyte layer 32 in the thickness direction. On the other hand, in the all-solid-state battery 10C shown in FIG. 3B, the low-elastic-modulus member 40 is disposed between the first solid electrolyte layer 31 covering the outer region R2 and the second solid electrolyte layer 32 in the thickness direction.

Since the all-solid-state battery 10C in this embodiment has the space 30 or the low-elastic-modulus member 40, excessive stress concentration in the area near the perimeter of the first electrode layer 2 is less likely to occur for the reason described above. Thus, cracking of the first electrode layer is less likely to occur. Moreover, in this embodiment, cracking in the area near the perimeter of the solid electrolyte layer is also less likely to occur. Thus, internal short circuit is less likely to occur.

In this embodiment, it is preferable that a surface (outer region R31), on the side of the second electrode layer 4, of the first solid electrolyte layer 31 covering the outer region R2 be an inclined surface having a curvature. On the other hand, this surface is not limited to an inclined surface having a curvature, and may be an inclined surface with one angle or may be an inclined surface with a plurality of angles. Thus, concentration of stress in an area near a perimeter of the first solid electrolyte layer and in the area near the perimeter of the first electrode layer is even less likely to occur. In this embodiment, the outer region R31 is normally disposed apart from the second solid electrolyte layer 32. The shape of the first electrode layer 2 in this embodiment can be the same shape as in the first embodiment.

In this embodiment, the first solid electrolyte layer 31 has, for example, a first surface S311 and a second surface S312 that face each other, and an end surface S31t that couples the first surface S311 and the second surface S312 together. The first surface S311 is a surface of the first solid electrolyte layer 31 on the side of the second electrode layer 4, and the second surface S312 is a surface of the first solid electrolyte layer 31 on the side of the first electrode layer 2. In this embodiment, the first surface S311 of the first solid electrolyte layer 31 includes the outer region R31 including an end portion E31.

In this embodiment, as seen in a sectional view in the thickness direction, a ratio (H3/W3) of the distance (H3 in FIG. 3A and FIG. 3B) between the end portion E31 and the second solid electrolyte layer 32 to the width (W3 in FIG. 3A and FIG. 3B) of the outer region R31 of the first solid electrolyte layer 31 is, for example, 1/50 or higher, and may be 1/10 or higher. On the other hand, this ratio (H3/W3) is, for example, 1 or lower, and may be ⅕ or lower. Specifically, H3 is, for example, 40 μm or larger and 100 μm or smaller, and W3 is, for example, 400 μm or larger and 500 μm or smaller.

In this embodiment, it is preferable that, as seen in a plan view of the all-solid-state battery, the area of the second solid electrolyte layer 32 be equal to that of the second electrode layer 4 or larger than that of the second electrode layer 4. That is, it is preferable that an end surface S32t of the second solid electrolyte layer 32 be located at the same position as the end surface S4t of the second electrode layer 4 or outward of the end surface S4t. This is because precipitation of Li in an area near the end portion of the second electrode layer is less likely to occur when the entire surface of the second electrode layer is in contact with the second solid electrolyte layer 32.

### 2. Members of All-Solid-State Battery

In this disclosure, the first current collector and the first electrode layer may be a positive electrode current collector and a positive electrode active material layer, respectively. In this case, the second current collector and the second electrode layer are a negative electrode current collector and a negative electrode active material layer, respectively. Conversely, the first current collector and the first electrode layer may be a negative electrode current collector and a negative electrode active material layer, respectively. In this case, the second current collector and the second electrode layer are a positive electrode current collector and a positive electrode active material layer, respectively.

### (1) Second Electrode Layer

In this disclosure, the second electrode layer includes a second active material that changes in volume during charge and discharge. It is preferable that the second active material be an active material of which the volume expands due to charge and the volume contracts due to discharge. On the other hand, the second active material may be an active material of which the volume expands due to discharge and the volume contracts due to charge. A volume expansion ratio during charge or a volume expansion ratio during discharge of the active material that changes in volume during charge and discharge is, for example, 105% or higher, and may be 110% or higher, may be 150% or higher, or may be 200% or higher.

When the second electrode layer is a negative electrode active material layer, examples of the second active material (negative electrode active material) include alloy-based active materials containing a metal that can form an alloy with lithium, such as Sn or Si (e.g., an Si-based active material, an Sn-based active material), a carbon active material, and metallic lithium (Li). Among these materials, an alloy-based active material is preferable. This is because of its high volume expansion ratio.

An Si-based active material is an active material containing an Si element. Examples of Si-based active materials include Si as a simple substance, an Si alloy, and an Si oxide. It is preferable that the Si alloy contain an Si element as a main component. A ratio of the Si element in the Si alloy may be, for example, 50 mol % or higher, may be 70 mol % or higher, or may be 90 mol % or higher. Examples of Si alloys include an Si—Al-based alloy, an Si—Sn-based alloy, an Si—In-based alloy, an Si—Ag-based alloy, an Si—Pb-based alloy, an Si—Sb-based alloy, an Si—Bi-based alloy, an Si—Mg-based alloy, an Si—Ca-based alloy, an Si—Ge-based alloy, and an Si—Pb-based alloy. The Si alloy may be two-component alloy or may be a multi-component alloy composed of three or more components. One example of Si oxides is SiO.

An Sn-based active material is an active material containing an Sn element. Examples of Sn-based active materials include Sn as a simple substance and an Sn alloy. It is preferable that the Sn alloy contain an Sn element as a main component. A ratio of the Sn element in the Sn alloy may be, for example, 50 mol % or higher, may be 70 mol % or higher, or may be 90 mol % or higher.

Examples of carbon active materials include mesocarbon microbeads (MCMB), highly oriented pyrolytic graphite (HOPG), hard carbon, and soft carbon.

These negative electrode active materials may be used alone, or two or more types of negative electrode active materials may be used in combination.

One example of the form of the negative electrode active material is a particle form. The mean particle diameter (D50) of the negative electrode active material is, for example, 10 nm or larger, and may be 100 nm or larger. On the other hand, the mean particle diameter (D50) of the negative electrode active material is, for example, 50 μm or smaller, and may be 20 μm or smaller. The mean particle diameter (D50) can be calculated, for example, from a measurement by a laser diffraction-type particle size distribution analyzer or a scanning electron microscope (SEM).

When the second electrode layer is a positive electrode active material layer, examples of the second active material (positive electrode active material) include a lithium-nickel composite oxide, a lithium-cobalt composite oxide, a lithium-iron composite oxide, a lithium-nickel-cobalt composite oxide such as LiNi_{1/3}Co_{1/3}Mn_{1/3}O₂, a lithium-metal phosphate compound, and a lithium-transition metal sulfated compound. These positive electrode active materials may be used alone, or two or more types may be used in combination.

The second electrode layer may further contain at least one of a conduction agent, a solid electrolyte, and a binder. One example of conduction agents is a carbon material. The solid electrolyte may be an organic solid electrolyte, such as a gel electrolyte, or may be an inorganic solid electrolyte, such as an oxide solid electrolyte or a sulfide solid electrolyte. Examples of binders include a rubber-based binder and a fluoride-based binder.

### (2) First Electrode Layer

The first electrode layer includes a first active material. When the first electrode layer is a positive electrode active material layer, the first active material (positive electrode active material) included in the first electrode layer is not particularly limited. That is, in addition to the positive electrode active materials named as examples in the above description of the second active material, conventionally commonly known active materials can be used.

When the first electrode layer is a negative electrode active material layer, the first active material (negative electrode active material) included in the first electrode layer is not particularly limited. That is, in addition to the negative electrode active materials named as examples in the above description of the second active material, conventionally commonly known active materials can be used.

The first electrode layer may further contain at least one of a conduction agent, a solid electrolyte, and a binder. As the conduction agent, the solid electrolyte, and the binder, the same ones that have been described above are used.

### (3) First Current Collector and Second Current Collector

The negative electrode current collector collects a current from the negative electrode active material layer. Examples of the material of the negative electrode current collector include metals such as copper, SUS, and nickel. One example of the form of the negative electrode current collector is a foil form. The negative electrode current collector may have a carbon coating layer on a surface on the side of the negative electrode active material layer.

The positive electrode current collector collects a current from the positive electrode active material layer. Examples of the material of the positive electrode current collector include metals such as aluminum, SUS, and nickel. One example of the form of the positive electrode current collector is a foil form. The positive electrode current collector may have a carbon coating layer on a surface on the side of the positive electrode active material layer.

### (4) Solid Electrolyte Layer

The solid electrolyte layer is disposed between the first electrode layer and the second electrode layer and contains at least a solid electrolyte. For the type of the solid electrolyte, the same contents that have been described above apply. The solid electrolyte layer may have a single-layer structure as shown in FIG. 1A, FIG. 1B, FIG. 2A, and FIG. 2B, or may have a stacked structure in which a plurality of layers is stacked as shown in FIG. 3A and FIG. 3B.

### (5) All-Solid-State Battery

The all-solid-state battery may have one, two, or three or more power generation units each composed of the first electrode layer, the solid electrolyte layer, and the second electrode layer. When the all-solid-state battery has a plurality of power generation units, these units may be connected in parallel or may be connected in series.

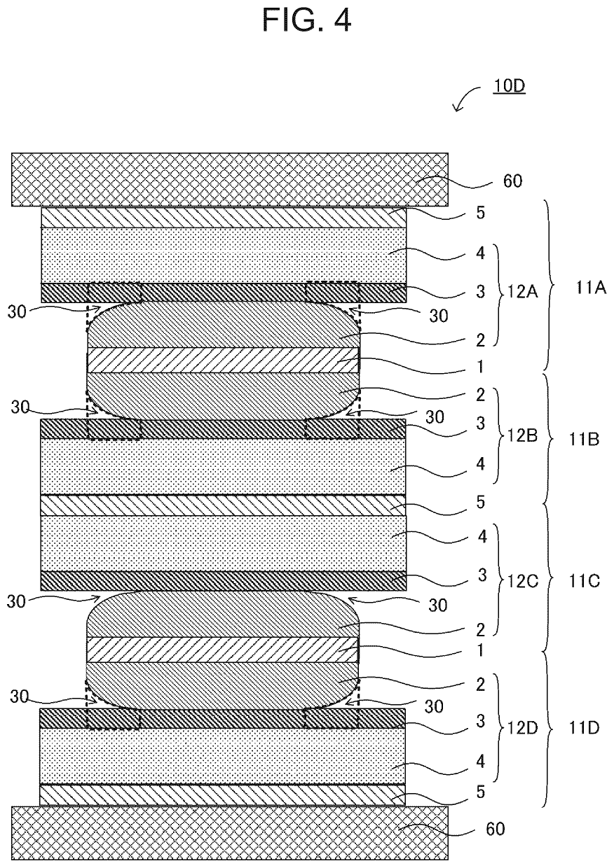

FIG. 4 is a schematic sectional view illustrating an all-solid-state battery in this disclosure. An all-solid-state battery 10D shown in FIG. 4 includes four electrode stacks 11 (11A, 11B, 11C, and 11D). The electrode stack 11A has the first current collector 1, a power generation element 12A (the first electrode layer 2, the solid electrolyte layer 3, and the second electrode layer 4), and the second current collector 5 in this order. An electrode stack 11B has the first current collector 1, a power generation element 12B (the first electrode layer 2, the solid electrolyte layer 3, and the second electrode layer 4), and the second current collector 5 in this order. On the other hand, an electrode stack 11C has the first current collector 1, a power generation element 12C (the first electrode layer 2, the solid electrolyte layer 3, and the second electrode layer 4), and the second current collector 5 in this order. An electrode stack 11D has the first current collector 1, a power generation element 12D (the first electrode layer 2, the solid electrolyte layer 3, and the second electrode layer 4), and the second current collector 5 in this order. The electrode stack 11A and the electrode stack 11B share one first current collector 1; the electrode stack 11B and the electrode stack 11C share one second current collector 5; and the electrode stack 11C and the electrode stack 11D share one first current collector 1. These stacks 11A to 11D are connected in parallel to one another.

The all-solid-state battery in this disclosure normally has an outer casing that covers the electrode stack including the first current collector, the first electrode layer, the solid electrolyte layer, the second electrode layer, and the second current collector. The outer casing may be a laminate-type outer casing or may be a case-type outer casing.

It is preferable that the all-solid-state battery in this disclosure include restraining members. The restraining members are members that apply a restraining pressure to the electrode stack in the thickness direction. The configuration of the restraining members is not particularly limited, and a commonly known configuration can be adopted. As the restraining pressure is applied, favorable ion conduction path and electron conduction path are formed. The restraining pressure is, for example, 0.1 MPa or higher, and may be 1 MPa or higher or may be 5 MPa or higher. On the other hand, the restraining pressure is, for example, 100 MPa or lower, and may be 50 MPa or lower or may be 20 MPa or lower.

The all-solid-state battery in this disclosure is typically a lithium-ion secondary battery. One example of applications of the all-solid-state battery is a power source of a vehicle, such as a hybrid electric vehicle (HEV), a plug-in hybrid electric vehicle (PHEV), a battery electric vehicle (BEV), a gasoline vehicle, or a diesel vehicle. In particular, it is preferable that the all-solid-state battery be used as a drive power source of a hybrid electric vehicle (HEV), a plug-in hybrid electric vehicle (PHEV), or a battery electric vehicle (BEV). Alternatively, the all-solid-state battery in this disclosure may be used as a power source of a mobile body other than vehicles (e.g., a railroad, a ship, or an airplane), or may be used as a power source of an electric product, such as an information processing device.

B. Manufacturing Method of all-Solid-State Battery

A manufacturing method of an all-solid-state battery in this disclosure is a manufacturing method of the above-described all-solid-state battery, and has: a first stack preparation step of preparing a first stack having the first current collector and the first electrode layer; a second stack preparation step of preparing a second stack having the second current collector and the second electrode layer; a first stack pressure-molding step of performing pressure-molding on the first stack; and a stacking step of, after the first stack pressure-molding step, stacking the first stack and the second stack through the solid electrolyte layer. In the first stack pressure-molding step, isostatic pressing is performed to decrease the thickness of the first electrode layer from a border between an inner region and an outer region toward the end portion.

According to this disclosure, isostatic pressing is performed in the first stack pressure-molding step to thereby decrease the thickness of the first electrode layer from the border between the inner region and the outer region toward the end portion. Thus, an all-solid-state battery can be obtained in which damage to an area near a perimeter of the first electrode layer due to charge and discharge is less likely to occur.

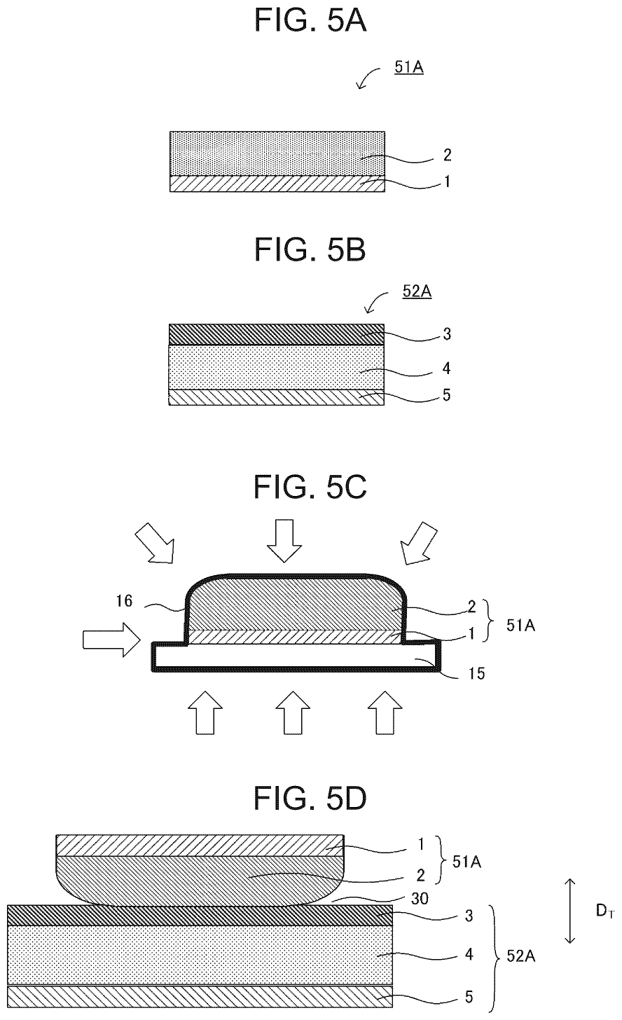

In the following, each step of the manufacturing method of the all-solid-state battery in this disclosure will be described in detail using FIG. 5A, FIG. 5B, FIG. 5C, and FIG. 5D. FIG. 5A, FIG. 5B, FIG. 5C, and FIG. 5D are schematic sectional views showing one example of the manufacturing method of the all-solid-state battery of the above-described first embodiment.

### 1. First Stack Preparation Step

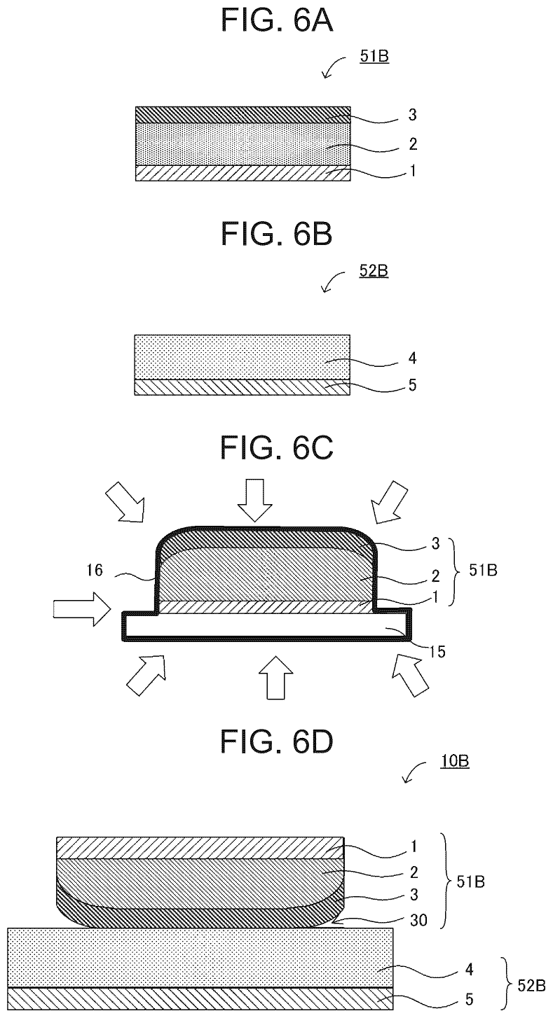

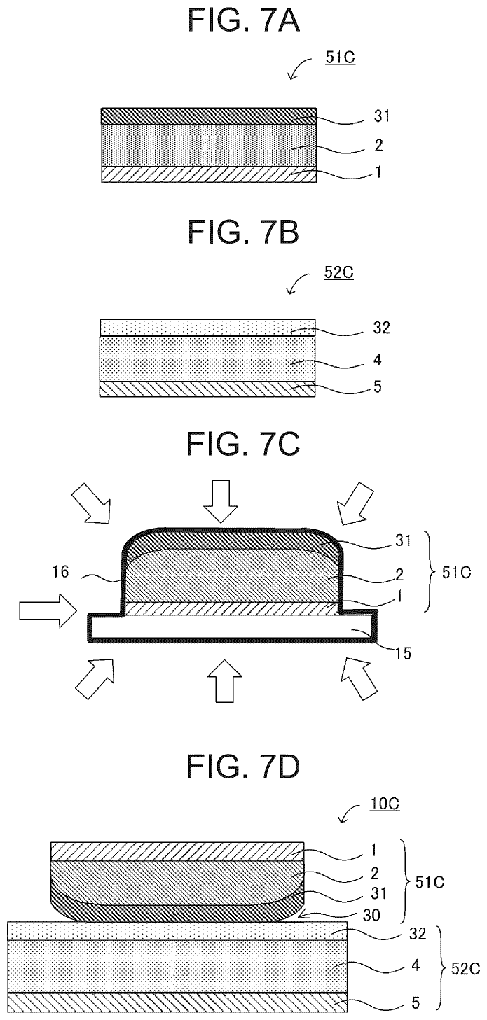

This step is a step of preparing the first stack having the first current collector and the first electrode layer. As shown in FIG. 5A, a first stack 51A has the first current collector 1 and the first electrode layer 2. As shown in FIG. 6A, FIG. 6B, FIG. 6C, FIG. 6D, FIG. 7A, FIG. 7B, FIG. 7C, and FIG. 7D to be described later, the first stack may have a solid electrolyte layer on a surface of the first electrode layer on the opposite side from the first current collector.

The first stack is produced, for example, by forming the first electrode layer on the first current collector 1. One example of the method of forming the first electrode layer is to apply slurry for forming the first electrode layer and drying the slurry (application method). A solid electrolyte layer may be further formed on the first electrode layer. One example of the method of forming the solid electrolyte layer is to transfer the solid electrolyte layer onto the first electrode layer using a sheet that has the solid electrolyte layer formed on a metal foil (transfer method).

### 2. Second Stack Preparation Step

This step is a step of preparing the second stack having the second current collector and the second electrode layer. As shown in FIG. 5B, a second stack 52A has the second current collector 5 and the second electrode layer 4. As shown in FIG. 5B, the second stack 52A may have the solid electrolyte layer 3 on the surface of the second electrode layer 4 on the opposite side from the second current collector 5. The methods of forming the second electrode layer and the solid electrolyte layer are the same as the methods of forming the first electrode layer and the solid electrolyte layer.

### 3. First Stack Pressure-Molding Step

This step is a step of performing pressure-molding on the first stack, and is a step of performing isostatic pressing to thereby decrease the thickness of the first electrode layer from the border between the inner region and the outer region toward the end portion.

In this step, as shown in FIG. 5C, it is preferable that isostatic pressing be performed without a support plate being disposed on a surface of the first stack 51A on the side of the first electrode layer 2. “The surface of the first stack on the side of the first electrode layer” refers to the surface of the first stack that is located on the side of the first electrode layer with respect to the first current collector. By such isostatic pressing, an inclination is provided in the outer region of the surface (first surface), on the opposite side from the first current collector, of the first electrode layer on which a support plate is not disposed. Thus, the thickness of the first electrode layer can be easily decreased from the border between the inner region and the outer region of the first surface toward the end portion. The support plate is not particularly limited as long as it is a member having higher rigidity than the first stack. On the other hand, it is preferable that a support plate 15 be disposed on the side of the first current collector 1 of the first stack 51A. As a result of isostatic pressing, the surface of the first stack on the side of the first current collector on which the support plate is disposed becomes flat.

As a pressure medium for isostatic pressing, a liquid, such as water or oil, powder, etc. can be named. It is more preferable that a liquid be used as the pressure medium. A pressure in isostatic pressing is not particularly limited, and can be, for example, 10 to 1000 MPa, preferably 100 to 500 MPa. A pressing time is not particularly limited, and can be, for example, one to 120 minutes, preferably five to 30 minutes. Further, a temperature of the pressure medium during pressing is not particularly limited either, and can be, for example, 20 to 200° C., preferably 50 to 100° C.

As shown in FIG. 5C, it is preferable that the first stack 51A be subjected to isostatic pressing in a state where it is sealed by a laminate film 16 along with the support plate 15 and shut off from an external atmosphere. Further, a release film for preventing adhesion may be disposed between the first stack and the support body and between the support body and the laminate film.

### 4. Stacking Step

This step is a step of, after the first stack pressure-molding step, stacking the first stack and the second stack through a solid electrolyte layer. As shown in FIG. 5B, when the second stack 52A has the solid electrolyte layer 3, the first stack 51A and the second stack 52A are stacked so as to face each other through the solid electrolyte layer 3 of the second stack (FIG. 5D). When the first stack has a solid electrolyte layer, the first stack and the second stack are stacked so as to face each other through the solid electrolyte layer of the first stack. Thus, the all-solid-state battery 10A is manufactured. When manufacturing an all-solid-state battery in which a low-elastic-modulus member is disposed, in the stacking step, the first stack and the second stack are stacked with the low-elastic-modulus member interposed between the first stack and the second stack.

### 5. Other Embodiments

FIG. 6A, FIG. 6B, FIG. 6C, and FIG. 6D are schematic sectional views showing one example of the manufacturing method of the all-solid-state battery of the above-described second embodiment. As shown in FIG. 6A, a first stack 51B is prepared that has the first current collector 1 and the first electrode layer 2 and further has the solid electrolyte layer 3 on the surface of the first electrode layer 2 on the opposite side from the first current collector 1. As shown in FIG. 6B, a second stack 52B having the second current collector 5 and the second electrode layer 4 is prepared.

Next, as shown in FIG. 6C, in the first stack pressure-molding step, isostatic pressing is performed, with the support plate 15 being disposed on the first stack 51B, on the side of the first current collector 1, and without a support plate being disposed on a surface of the first stack 51B on the side of the first electrode layer 2 (the surface of the solid electrolyte layer). As a result of isostatic pressing, the surface of the first stack on the side of the first current collector on which the support plate is disposed becomes flat. On the other hand, an inclination is provided in the outer regions of the surfaces of the first electrode layer 2 and the solid electrolyte layer 3 on which a support plate is not disposed. Thus, the thickness of the first electrode layer can be easily decreased from the border between the inner region and the outer region of the first surface of the first electrode layer toward the end portion.

Next, as shown in FIG. 6D, in the stacking step, the first stack 51B and the second stack 52B are stacked so as to face each other through the solid electrolyte layer 3 of the first stack 51B. Thus, the all-solid-state battery 10B of the second embodiment is manufactured.

FIG. 7A, FIG. 7B, FIG. 7C, and FIG. 7D show one example of the manufacturing method of the all-solid-state battery of the above-described third embodiment. First, as shown in FIG. 7A, a first stack 51C is prepared that has the first current collector 1 and the first electrode layer 2 and further has the first solid electrolyte layer 31 on the surface of the first electrode layer 2 on the opposite side from the first current collector 1. As shown in FIG. 7B, a second stack 52C is prepared that has the second current collector 5 and the second electrode layer 4 and further has the second solid electrolyte layer 32 on the surface of the second electrode layer 4 on the opposite side from the second current collector 5.

Next, as shown in FIG. 7C, in the first stack pressure-molding step, isostatic pressing is performed, with the support plate 15 being disposed on the first stack 51C, on the side of the first current collector 1, and without a support plate being disposed on a surface of the first stack 51C on the side of the first electrode layer 2 (the surface of the first solid electrolyte layer). As a result of isostatic pressing, the surface of the first stack on the side of the first current collector on which the support plate is disposed becomes flat. On the other hand, an inclination is provided in the outer regions of the surfaces of the first electrode layer 2 and the first solid electrolyte layer 31 on which a support plate is not disposed. Thus, the thickness of the first electrode layer can be easily decreased from the border between the inner region and the outer region of the first surface of the first electrode layer toward the end portion.

Next, as shown in FIG. 7D, in the stacking step, the first stack 51C and the second stack 52C are stacked so as to face each other through the first solid electrolyte layer 31 of the first stack 51C and the second solid electrolyte layer 32 of the second stack 52C. Thus, the all-solid-state battery 10C of the third embodiment is manufactured.

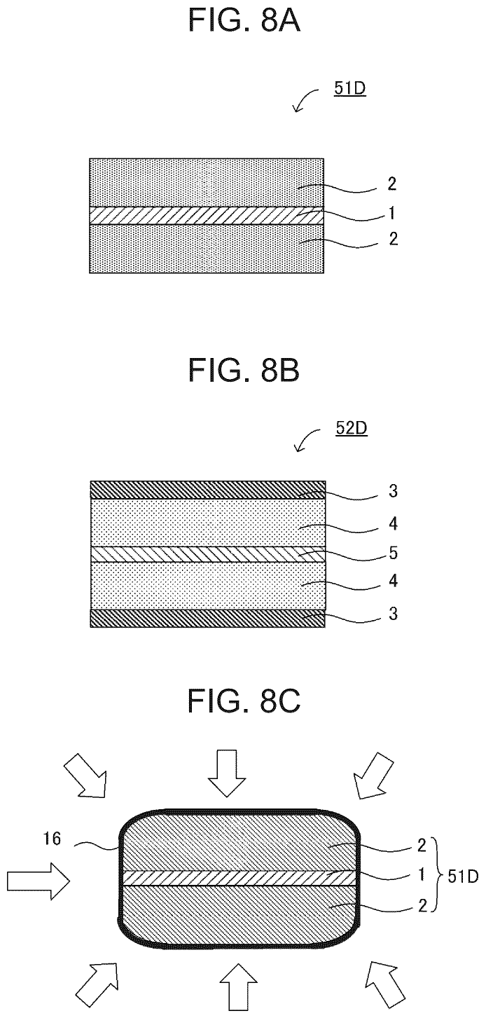

FIG. 8A, FIG. 8B, and FIG. 8C are schematic sectional views showing one example of the manufacturing method of an all-solid-state battery in the case where the all-solid-state battery is a stacked battery. First, as shown in FIG. 8A, a first stack 51D is prepared that has the first current collector 1 and the first electrode layers 2 formed on both surfaces of the first current collector 1. As shown in FIG. 8B, a second stack 52D is prepared that has the second current collector 5 and the second electrode layers 4 and the solid electrolyte layers 3 formed on both surfaces of the second current collector 5.

Next, as shown in FIG. 8C, in the first stack pressure-molding step, isostatic pressing is performed, without a support plate being disposed on either surface of the first stack 51D (the surfaces of the first electrode layers 2). As a result, an inclination is provided in the outer regions of the first surfaces of the first electrode layers 2 on both sides of the first stack 51D.

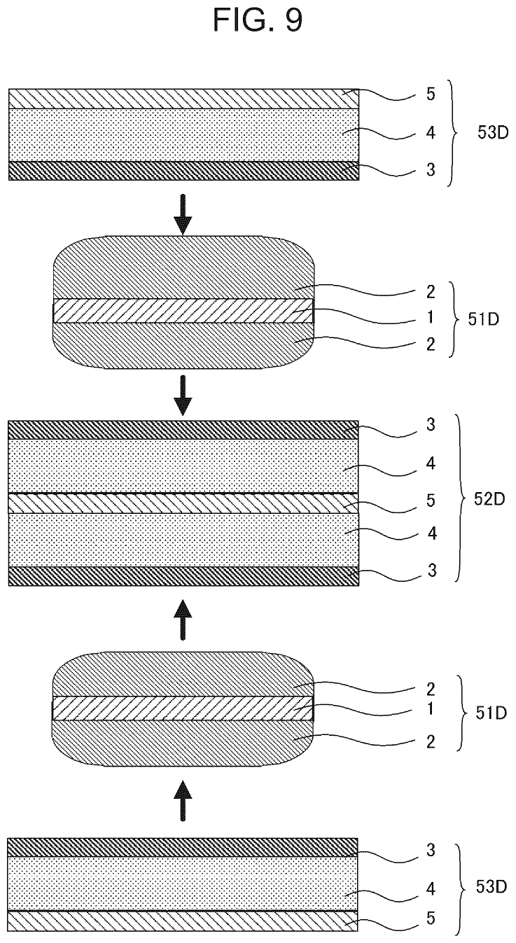

Next, as shown in FIG. 9, in the stacking step, the first stacks 51D are disposed on both sides of the second stack 52D. Further, third stacks 53D each having the solid electrolyte layer 3, the second electrode layer 4, and the second current collector 5 are disposed and stacked respectively on the first stacks 51D. Here, the third stacks 53D are disposed and stacked so that the solid electrolyte layers 3 are located on the sides of the first stacks 51D. Thus, the all-solid-state battery 10D of the fourth embodiment is manufactured.

This disclosure is not limited to the above-described embodiments. The above-described embodiments are shown as examples, and any embodiments that have substantially the same configuration as the technical idea described in the claims of this disclosure and have similar workings and advantages are included in the technical scope of this disclosure.

### Production of Cells for Evaluation

First, LiNi_{0.5}Co_{0.2}Mn_{0.3}O₂, an argyrodite sulfide solid electrolyte, a conduction aid, and a binder were dispersed in a solvent to prepare slurry for a positive electrode active material layer. The slurry for a positive electrode active material layer was applied to a positive electrode current collection foil and dried to produce a positive electrode sheet having a positive electrode current collector (first current collector) and a positive electrode active material layer (first electrode layer).

Next, silicon, an argyrodite sulfide solid electrolyte, a conduction aid, and a binder were dispersed in a solvent to prepare slurry for a negative electrode active material layer. The slurry for a negative electrode active material layer was applied to a negative electrode current collection foil and dried to produce a negative electrode sheet having a negative electrode current collector (second current collector) and a negative electrode active material layer (second electrode layer).

Next, an argyrodite solid electrolyte and a binder were dispersed in a solvent to prepare slurry, and this slurry was applied to a metal foil and dried to produce a first solid electrolyte sheet having a first solid electrolyte layer and a metal foil. Using the same method, a second solid electrolyte sheet having a second solid electrolyte layer and a metal foil was produced.

Next, each sheet of the positive electrode sheet, the negative electrode sheet, the first solid electrolyte sheet, and the second solid electrolyte sheet was cut to predetermined dimensions. Here, the negative electrode sheet was cut so as to have a larger area than the positive electrode sheet. The first solid electrolyte sheet and the second solid electrolyte sheet were cut so as to have larger areas than each of the cut positive electrode sheet and the cut negative electrode sheet.

Next, the positive electrode sheet and the first solid electrolyte sheet were layered such that the positive electrode active material layer and the first solid electrolyte layer faced each other to obtain a first stack. This first stack was disposed on a stainless-steel plate, and was vacuum-sealed by an aluminum laminate film along with the stainless-steel plate serving as a support plate. Here, the first stack was disposed such that the side of the positive electrode sheet was on the side of the stainless-steel plate. The vacuum-sealed first stack was subjected to a warm isostatic pressing (WIP) process (first stack pressure-molding step). Thereafter, the aluminum laminate film was opened to take out the first stack, and the metal foil on the side of the solid electrolyte layer was removed. Thus, a positive electrode active material layer was obtained on which the solid electrolyte layer was transferred and which was highly filled.

The second solid electrolyte sheet and the negative electrode sheet were layered such that the second solid electrolyte layer of the former and the negative electrode active material layer of the latter faced each other and bonded together by a roll press, and thereafter the metal foil on the side of the second solid electrolyte layer was removed. Thus, a second stack having the negative electrode current collector, the negative electrode active material layer, and the second solid electrolyte layer was obtained.

The obtained first stack and second stack were layered such that the first solid electrolyte layer of the former and the second solid electrolyte layer of the latter faced each other, and were vacuum-sealed by a laminate film along with a current collection tab to produce an all-solid-state battery. The obtained all-solid-state battery was restrained with restraining jigs having a flat plate shape to apply a predetermined surface pressure.

### Comparative Example

An all-solid-state battery was produced by the same method as in Example except that in the first stack pressure-molding step, the solid electrolyte sheet was disposed on the side of the stainless-steel plate.

### Charge-Discharge Test

Charge and discharge for conditioning were conducted under predetermined conditions on the all-solid-state batteries manufactured in Example and Comparative Example, and then a charge-discharge test at 60° C. within a voltage range of 2.5 to 4.35 V was conducted. Charge was conducted at 1C, 2C, 3C, 4C, 5C, and 6C (CC charge), and a discharge rate was 0.1C (CCCV discharge, with a cut-off rate of 0.1C), and a ratio of a discharge capacity (CCCV capacity) to a charge capacity (CC capacity) was calculated as coulombic efficiency.

FIG. 12 shows a result of comparing coulombic efficiencies at each charge rate in Example and Comparative Example. It was confirmed that at each charge rate, the coulombic efficiency of Example was higher than the coulombic efficiency of Comparative Example. When short circuit occurs, a current due to the short circuit flows in a larger amount during charge, resulting in lower coulombic efficiency. Therefore, this result shows that the likelihood of short circuit is reduced in Example.

A cross-sectional shape of each all-solid-state battery before the charge-discharge test was observed by an SEM. It was confirmed that in the all-solid-state battery of Example, the outer region of the first surface of the positive electrode active material layer (first electrode layer) and the surface, on the side of the second solid electrolyte layer, of the first solid electrolyte layer covering this outer region were inclined. Further, it was confirmed that there was a space between the first solid electrolyte layer covering the outer region of the first surface of the positive electrode active material layer (first electrode layer) and the second solid electrolyte layer. On the other hand, it was confirmed that in the all-solid-state battery of Comparative Example, the surfaces of the positive electrode active material layer (first electrode layer) and the first solid electrolyte layer on the side of the second solid electrolyte layer were not inclined while the outer region of the surface of the first electrode layer on the side of the first current collector was inclined.

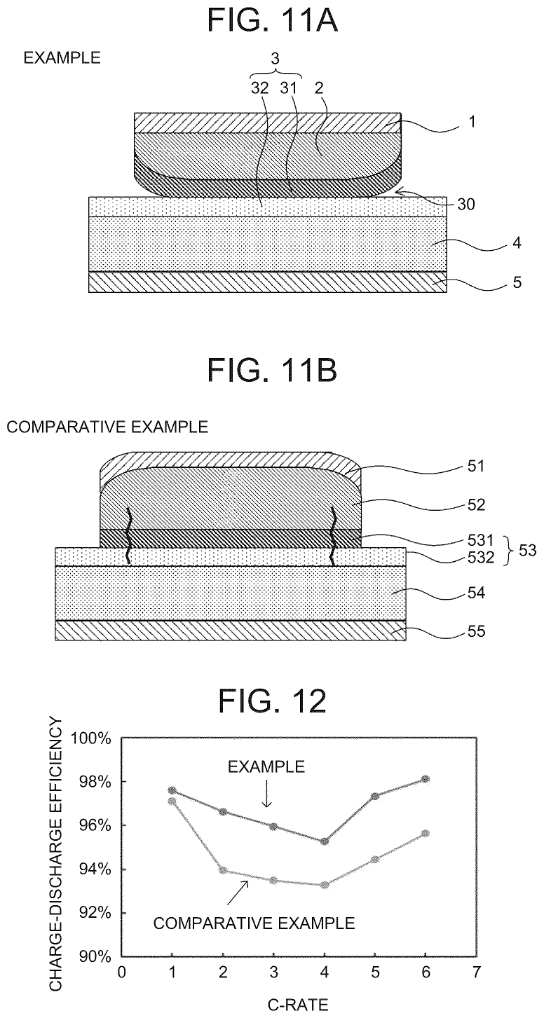

A cross-sectional shape of each battery after the charge-discharge test was observed by an SEM. Schematic views of the observed cross-sectional shapes are shown in FIG. 11A and FIG. 11B. As shown in FIG. 11A, in the battery of Example, no significant cracks were found in the positive electrode active material layer (first electrode layer 2) and the solid electrolyte layer 3. In contrast, as shown in FIG. 11B, in the battery of Comparative Example, obvious cracks were observed in the areas near the perimeters of the positive electrode active material layer (first electrode layer 52) and the solid electrolyte layer 53 (a first solid electrolyte layer 531 and a second solid electrolyte layer 532).

What is claimed is:

1. An all-solid-state battery comprising a first current collector, a first electrode layer, a solid electrolyte layer, a second electrode layer, and a second current collector in this order, wherein:
the first electrode layer includes a first active material;
the second electrode layer includes a second active material that changes in volume during charge and discharge;
when the all-solid-state battery is seen in a plan view from a thickness direction, an area of the second electrode layer is larger than an area of the first electrode layer;
a first surface of the first electrode layer on a side of the solid electrolyte layer has an inner region and an outer region that is disposed on an outer side of the inner region and includes an end portion; and
the all-solid-state battery has, between the outer region and the second electrode layer in the thickness direction, the solid electrolyte layer and either (i) a space or (ii) a low-elastic-modulus member having a lower elastic modulus than the second electrode layer and the solid electrolyte layer.

2. The all-solid-state battery according to claim 1, wherein a thickness of the first electrode layer decreases from a border between the inner region and the outer region toward the end portion.

3. The all-solid-state battery according to claim 1, wherein the space is disposed between the outer region and the solid electrolyte layer in the thickness direction.

4. The all-solid-state battery according to claim 1, wherein the low-elastic-modulus member is disposed between the outer region and the solid electrolyte layer in the thickness direction.

5. The all-solid-state battery according to claim 1, wherein:
the solid electrolyte layer is disposed so as to cover the inner region and the outer region; and
the space is disposed between the solid electrolyte layer covering the outer region and the second electrode layer in the thickness direction.

6. The all-solid-state battery according to claim 1, wherein:
the solid electrolyte layer is disposed so as to cover the inner region and the outer region; and
the low-elastic-modulus member is disposed between the solid electrolyte layer covering the outer region and the second electrode layer in the thickness direction.

7. The all-solid-state battery according to claim 1, wherein:
the solid electrolyte layer has a first solid electrolyte layer and a second solid electrolyte layer from a side of the first electrode layer;
the first solid electrolyte layer is disposed so as to cover the inner region and the outer region;
the second solid electrolyte layer is disposed in contact with the second electrode layer; and
the space is disposed between the first solid electrolyte layer covering the outer region and the second solid electrolyte layer in the thickness direction.

8. The all-solid-state battery according to claim 1, wherein:
the solid electrolyte layer has a first solid electrolyte layer and a second solid electrolyte layer from a side of the first electrode layer;
the first solid electrolyte layer is disposed so as to cover the inner region and the outer region;
the second solid electrolyte layer is disposed in contact with the second electrode layer; and
the low-elastic-modulus member is disposed between the first solid electrolyte layer covering the outer region and the second solid electrolyte layer in the thickness direction.

9. The all-solid-state battery according to claim 1, wherein the second electrode layer is a negative electrode active material layer and includes an alloy-based active material as the second active material.

10. A manufacturing method of the all-solid-state battery according to claim 1, comprising:
a first stack preparation step of preparing a first stack having the first current collector and the first electrode layer;
a second stack preparation step of preparing a second stack having the second current collector and the second electrode layer;
a first stack pressure-molding step of performing pressure-molding on the first stack; and
a stacking step of, after the first stack pressure-molding step, stacking the first stack and the second stack through the solid electrolyte layer, wherein
in the first stack pressure-molding step, isostatic pressing is performed to decrease a thickness of the first electrode layer from a border between the inner region and the outer region toward the end portion.

11. The manufacturing method of the all-solid-state battery according to claim 10, wherein the isostatic pressing is performed without a support plate being disposed on a surface of the first stack on a side of the first electrode layer.
